(19) United States
(12) Patent Application Publication
(10) Pub. No.: US 2004/0055691 A1
(43) Pub. Date: Mar. 25, 2004

(54) Method and apparatus for making a laminate

(76) Inventors: A. Bruce Plumley, Middletown, CT (US); Shawn Cole, Tolland, CT (US)

Correspondence Address: Donald J. MacDonald, McCormick, Paulding & Huber LLP, City Place II, 185 Asylum Street, Hartford, CT, 06103, US

(21) Appl. No.: 10/606,535

(22) Filed: Jun. 26, 2003

Related U.S. Application Data
(60) Provisional application No. 60/391,771, filed on Jun. 26, 2002.

(51) Int. Cl. B32B 31/10; B32B 31/18; B32B 31/20

(52) U.S. Cl. 156/64; 156/250; 156/289; 156/350; 156/379; 156/510; 156/522; 156/537; 156/552

(57) ABSTRACT

The present invention provides a method and apparatus for making a laminate. The method including providing a work material such as a hide, and a backing material and moving one of the work material and the backing material into engagement with one another and adhesively bonding the backing material to the work material thereby forming a laminate. The apparatus includes a first support surface for carrying a work material, a second support surface positioned adjacent the first support surface, and means for transferring the work material between the first and second support surfaces. A roll of backing material is rotatably and operably positioned relative to the first and second support surfaces so that during movement of the work material between the first and second support surfaces the backing material can be fed from the roll into engagement with a surface defined by the work material to form a laminate.

### CROSS REFERENCE TO RELATED APPLICATION

The present application claims the benefit of, and incorporates herein by reference, co-pending U.S. Provisional Patent Application No. 60/391,771 filed on Jun. 26,2002 and assigned to Gerber Technology, Inc. Additionally, this application is related to co-pending U.S. patent application Ser. No. 09/150,277 filed on Sep. 9, 1998, the disclosure of which is incorporated herein by reference in its entirety.

### FIELD OF THE PRESENT INVENTION

The present invention generally relates to a method and apparatus for making a laminate from sheet-type work material, and is more specifically directed to a method and apparatus for adhering a backing material to a hide forming a laminate and cutting pattern pieces from the laminate.

### BACKGROUND OF THE PRESENT INVENTION

During the making of leather goods such as furniture, automobile seats, and luggage, hides of various animals are often used. A backing material such as foam can be attached to the hide for adding structure or cushion to the hide and to increase the durability of the hide. Hides are often cut into pattern pieces and then a foam backing or other material is attached to the backside thereof. Usually, the cutting of pattern pieces from a hide and the process of attaching a backing material to the pattern pieces are separate operations. Often, one or both of these operations are done manually using labor intensive and time consuming methods. Accordingly, many prior art processes for cutting pattern pieces from leather hides and for attaching a backing material to the hides are both costly and inefficient.

Based on the foregoing, it is the general object of the present invention to provide a method and apparatus that improves upon, or overcomes the problems and drawbacks associated with prior art methods for the processing of leather hides and similar work materials.

### SUMMARY OF THE PRESENT INVENTION

The present invention resides in a method and apparatus for processing sheet-type work material such as leather hides. The method includes attaching a backing material to a hide forming a laminate and cutting pattern pieces from the laminate.

In one aspect, the present invention is directed to a method for making a laminate wherein a backing material is bonded to a leather hide. The method includes moving at least one of the hide and the backing material into engagement with the other and adhesively bonding the hide to the backing material thereby forming a laminate.

The backing material can include a layer of adhesive disposed on a side thereof. Alternatively, the method includes applying a layer of adhesive to at least one of the hide and the backing material. A spray bar or other suitable mechanism can be provided to distribute an adhesive to at least one of the hide and the backing material prior to engaging one with the other.

In one embodiment of the present invention, the method includes compressing the laminate to enhance adhesion of the backing material to the hide. A pair of rollers having a nip there between can be provided and the hide and backing material passed between the rollers thereby compressing the laminate and adhering the backing material to the hide.

The backing material can be provided on a roll wherein the hide is moved into engagement with the backing material and the backing material is unrolled as necessary to engage a layer of the backing material with the entire surface of the hide. Preferably, the backing material is bonded to the underside or a rear surface of the hide. Following the engagement of the hide with the backing material, the method can include cutting the backing material to separate the backing material engaged with the hide from a supply roll thereof. Another hide can then be moved into engagement with a free end of the backing material.

A release material can be removably bonded to the adhesive for preventing the adhesive from adhering to the backing material in a roll thereof. In this case, the method of the invention includes removing the release material prior to engaging the backing material with the hide. The method can include providing a roller for collecting the release material thereon after it is removed from the backing material.

Additionally, a camera or other means for selectively capturing images, is operated to capture images of at least a portion of the hide. The operation of the camera is controlled by a computer or controller coupled to the camera. A plurality of images of the hide can be combined to provide a composite image thereof. Information relating to pattern pieces or parts to be cut from the laminate are stored in a computer memory coupled to the controller. The method of the invention includes nesting part peripheries corresponding to a plurality of pattern pieces to be cut from the laminate on an image of the hide. The nesting operation can be fully automated and performed by the computer. Alternatively, an operator can interact with the computer via input devices such as a joystick, mouse or keyboard to control some or all of the nesting process. The nesting operation results in a marker defining a plurality of pattern pieces positioned with respect to the image of the hide. The nesting operation may utilize the size and quality requirements for a pattern piece and the location of any flaws in the hide to determine the most efficient marker. Also, the periphery of the hide can be considered in defining the marker. Following the nesting of at least one pattern piece to be cut from the laminate, a cutting program is executed for controlling a cutter head to cut the pattern piece from the laminate.

In another aspect, the present invention includes an apparatus for making a laminate and cutting pattern pieces therefrom. The apparatus includes a first support surface for carrying a work material. A second support surface is located adjacent the first support surface. Means for transferring the work material between the first and second support surfaces is provided. A roll of backing material rotatably and operably positioned relative to the first and second support surfaces is provided so that during movement of the work material between the first and second support surfaces the backing material can be fed from the roll thereof into engagement with a surface defined by the work material to form a laminate. Means for feeding the backing material for engagement with the work material is provided. The laminate includes a work material such as a leather hide having a layer of backing material adhesively bonded thereto. Preferably, the backing material is a foam material such as that used in manufacturing leather seats for automobiles.

In one embodiment of the present invention, the apparatus includes means for applying an adhesive to one side of the work material or the backing material or both, for bonding the backing material to the work material. Further, the apparatus can include means for compressing the laminate to enhance the adhesion of the layers of the work material together. In the preferred embodiment of the present invention, a pair of nip rollers are provided for compressing the laminate.

The backing material can include a layer of adhesive disposed on a surface thereof. Additionally, a layer of release material removably bonded to the adhesive can be included with the backing material for protecting the adhesive or preventing the adhesive from bonding to the backing material in a roll thereof. In this case, the release material is removed or peeled from the adhesive prior to engaging the backing material with the work material. The apparatus of the invention can include means for collecting the release material following removal thereof from the backing material.

The apparatus of the invention further includes a computer or controller coupled to the first and second support surfaces for controlling the operation thereof. The controller can include a display and a user interface for operator control or monitoring of the apparatus.

One of the first and second support surfaces includes means for scanning a portion of the work material in response to signals from the controller for capturing areal images of a surface of the work material. A cutter head is coupled to the controller and movable with respect to one of the support surfaces. The cutter head includes a cutting tool such as a reciprocating knife and is coupled to the controller for cutting pattern pieces from the laminate according to a marker defining the position of the pattern pieces to be cut from the laminate relative to an image of the work material. The apparatus of the invention includes employing a nesting program for processing the images of the hide and stored data related to the pattern pieces to be cut from the laminate and defining the marker for efficient utilization of the area of the hide.

The controller generates a cutting program in accordance with the marker to cut the parts from the hide. The cutting program and nesting programs can be executed concurrently so that as soon as the marker defines a first pattern piece to be cut from the hide the cutting process can begin cutting the first piece.

### BRIEF DESCRIPTION OF THE DRAWINGS

FIG. 1 is a perspective view of a system according to the present invention for processing a hide, including sections for loading, scanning, adhering a backing material to, and cutting pattern pieces from the hide.

FIG. 2 is a side elevational view of a laminate made according to the method of the present invention.

### DESCRIPTION OF THE PREFERRED EMBODIMENTS OF THE PRESENT INVENTION

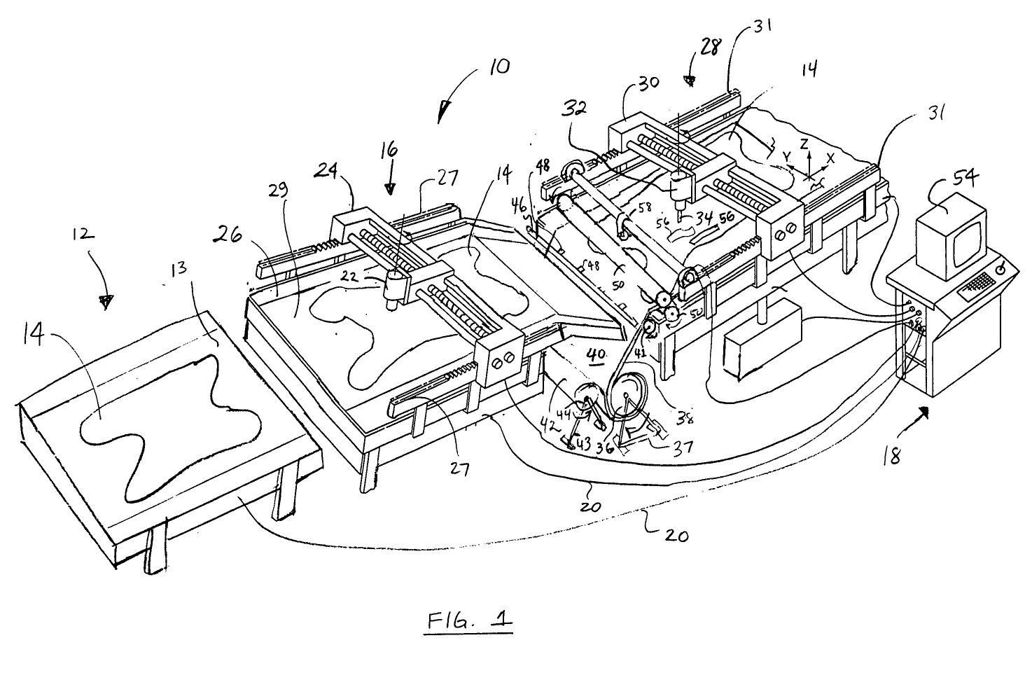

As illustrated in FIG. 1, a system for processing hides is designated generally by the reference numeral 10. The system 10 includes means for loading and scanning a hide, adhering a backing material to the hide forming a laminate, and cutting pattern pieces from the laminate.

In the embodiment shown, the system 10 is used for processing leather hides 14. The system 10 includes a loading table 12 upon which the hides 14 are initially positioned. A scanning table, designated generally by the reference number 16 is located adjacent to the loading table 12. During operation, the hides 14 are transferred from the loading table 12 to the scanning table 16 either manually, or via conveyors 13 and 29 disposed on one or both of the loading table 12 and the scanning table 16. Alternatively, other means such as rollers could be provided for automatically transferring the hides between the loading table 12 and the scanning table 16. A controller 18 controls the operation of the system 10 and communicates with both the loading table 12 and the scanning table 16, for example, via communication lines 20.

Continuing with FIG. 1, the scanning table 16 includes a camera 22 mounted on a carriage 24 extending transversely across a support surface 26. The carriage 24 is moveable back and forth along rails 27 in a first coordinate direction as indicated by the arrow labeled “X”, longitudinal of the table 16 in response to command signals generated and transmitted by the controller 18. The camera 22 is coupled to the carriage 24 for movement in a second coordinate direction indicated by the arrow labeled “Y” also in response to command signals generated by the controller 18. During operation, the camera 22 is moved over the hide 14 for capturing one or more areal images of the surface of the hide 14 to determine the periphery of the hide, the surface quality thereof, and the locations of any imperfections that may be present in the hide. Additionally, the camera 22 can be controlled to move perpendicular to the support surface 26 in a third coordinate direction as indicated by the arrow labeled “Z” for focusing the camera or for other purposes such as moving the camera to clear an obstacle. The controller 18 independently communicates with both the camera 22 and the carriage 24 for controlling the movement and operation of the camera and the carriage.

Still referring to FIG. 1, a cutting table 28 is located adjacent to the scanning table 16 and includes a second carriage 30 mounted on rails 31 and moveable longitudinally thereof, in the X-direction, in response to commands issued by the controller 18. A cutting head 32 having a suitable cutter, such as a reciprocating blade 34, mounted thereon is movably attached to the second carriage 30. Similar to the camera 22, the cutting head 32 is movable in the Y-coordinate direction longitudinally of the second carriage 30, generally transversely of the cutting table 28. The cutting head 30 is moved in response to commands issued from the controller 18 for cutting pattern pieces 56 from the laminate 52.

During operation, the hides 14 are transferred from the scanning table 16 to the cutting table 28 via a conveyor 29 or other means such as rollers. One or both of the scanning table 16 and the cutting table 28 can include conveyors or rollers to provide for automatic transfer of the hides 14 there between. The controller 18 communicates with the cutting table 28, for example, via a communication line 20.

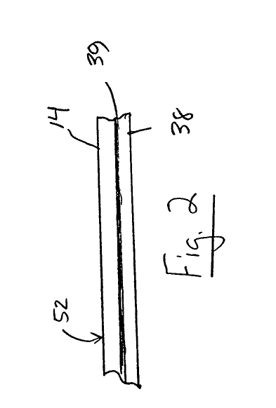

Referring to FIG. 1, a roller 36 is disposed between the scanning table 16 and the cutting table 28. The roller 36 has wound thereon a foam material 38 preferably of the type used to back leather upholstery for use in vehicles. As the hide 14 is transferred from the scanning table 16 to the cutting table 28, the foam material 38 is brought into engagement with a surface of the hide 14. The foam material 38 can include an adhesive layer 39 on a surface 40 thereof to bond the hide 14 and the foam material together forming a laminate 52. The laminate 52 is shown in FIG. 2. A release material 42 is releasably bonded to the adhesive layer 39 between layers of the foam material 38 on the roller 36 to prevent the adhesive layer 39 from sticking to the foam material. While the foam material 38 is advanced to the cutting table 28, the release material 42 is removed from the foam material and collected on a roller 44 supported on a stand 43. Alternatively, if the foam material 38 does not include an adhesive layer 39, an applicator such as a spray bar mechanism 46 including nozzles 48 apply an adhesive to one or both of the hide 14 and the foam material 38 prior to bringing the hide and the foam material into engagement with one another.

As shown in FIG. 1, a pair of rollers 50 are coupled for rotation relative to the cutting table 28 and form a nip there between through which the hide 14 and the foam material 38 pass and are compressed together to better form an adhesive bond there between. Accordingly, and as shown in FIG. 2, the hide 14 and the foam material 38 with a layer of adhesive 39 there between form the laminate 52.

At least one guide roller 41 is coupled to one of the scanning table 16 and the cutting table 28 or proximate thereto, to facilitate feeding the backing material 38 between the scanning table 16 and the cutting table 28 for engagement with the hide 14. The guide roller 41 can include an outer surface designed to engage the backing material for feeding the backing material. For example, the outer surface of the guide roller 41 can include a portion having an adhesive surface or a high coefficient of friction for engaging the backing material and for feeding the backing material into position for engaging the work material.

A wheel cutter 58 or other type of knife or cutter can be mounted to the rails 31 for cutting the foam material 38 once it has been adhered to the hide 14. In addition, instead of a separate cutter to cut the foam material 38, the cutter 34 mounted to the cutting head 32 can be employed to cut the foam material 38 from a roll thereof or other supply. Alternatively, the foam material 38 can be precut to length and then wound onto the roller 36 so that a length of foam material 38 will separate from the roll thereof without requiring a separate cutting process. If necessary, the foam material 38 can be trimmed by the cutter 34 or the wheel cutter 58.

A computer type monitor such as a display 54 is preferably in communication with the controller 18. While the controller 18 is preferably a PC type computer, the present invention is not limited in this regard as other types of controllers such as mainframes can be employed without departing from the scope of the present invention.

While the roller 36 has been shown as being disposed under the scanning table 16 and the cutting table 28, the present invention is not limited in this regard as the roller can be disposed in any other convenient location that allows the foam material 38 and the hide 14 to be joined. Moreover, a layer of the release material 42 can be applied to the adhesive-backed foam material 38 to prevent the foam material from sticking to itself while on the roller 36. The release material 42 can then be peeled from the foam material 38 prior to engagement with the hide 14.

The cutting operation includes storing in a memory of the controller 18 information relating to the pattern pieces 56 to be cut out from the hides 14 including a periphery of each pattern piece. Additionally, the stored information can include requirements for each pattern piece 56 including quality requirements of the hide 14 and matching information if the pattern piece is to be matched or positioned adjacent to another pattern piece to be cut. Data representing the areal images of the hides 14 captured by the camera 22 is also stored in the memory of the controller 18. The images of the hide 14 can be combined to form a composite image of the hide 14 to be shown on the display 54 for operator review. A nesting program is also stored in the memory of the controller 18 for processing the image data and pattern piece 56 information to form a marker defining the nesting arrangement of a plurality of pattern pieces 56 on the hide or hides 14. The nesting program can include processing flaw information with regard to defects in the hide 14, quality requirements for the pattern pieces 56 as well as matching information for matching each of the pattern pieces 56 with an adjacent pattern piece in a final assembly of an article. The nesting program determines the marker accordingly.

Following a determination of at least a portion of the marker or the placement of a pattern piece 56 on the hide 14 or the laminate 52, a cutting program determined by the controller 18 is executed to control the cutting head 32 to cut the pattern pieces 56 from the laminate 52. Alternatively, images of the pattern pieces can be shown on the display 54 for operator placement thereof on the laminate 52. Additionally, the marker defined by the nesting program can be shown on the display 54 for operator approval or adjustment thereof. The nesting and cutting programs utilized by the present invention are disclosed in detail in U.S. patent application Ser. No. 09/150,277 filed on Sep. 9, 1998, the disclosure of which is incorporated herein by reference in its entirety.

While a loading table 12, scanning table 16 and cutting table 28 have been shown and described, one or more of the loading table and scanning table may be eliminated, or all of the loading, scanning, and cutting tables can be combined without departing from the broader aspects of the invention.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A method of making a laminate comprising the steps of:
providing a hide;
providing a backing material;
moving at least one of said hide and said backing material into engagement with one another; and
adhesively bonding said hide and said backing material to one another thereby forming a laminate.

2. The method of claim 1 further comprising a step of applying an adhesive to at least one of said hide and said backing material for bonding said backing material to said hide.

3. The method of claim 1 further comprising a step of compressing said laminate to enhance adhesion of said backing material to said hide.

4. The method of claim 3 further comprising a step of providing a pair of rollers having a nip there between for compressing said laminate, and wherein said step of moving at least one of said hide and said backing material into engagement with one another includes feeding said hide and said backing material between said rollers.

5. The method of claim 1 wherein after the step of adhesively bonding, further comprising a step of cutting said backing material for separating said backing material from a supply thereof.

6. The method of claim 1 further comprising a step of providing said backing material including a layer of adhesive disposed on a side thereof for bonding said backing material to said hide.

7. The method of claim 6 further comprising providing said backing material having a layer of release material removably bonded to said adhesive.

8. The method of claim 7 further comprising the step of removing said release material from said adhesive prior to engaging said backing material with said hide.

9. The method of claim 8 wherein after the step of removing said release material, further comprising a step of providing a roller for collecting said release material thereon.

10. The method of claim 2 wherein prior to the step of moving, further comprising a step of providing means for applying an adhesive to at least one of said hide and said backing material.

11. The method of claim 1 further comprising a step of capturing at least one areal image of a portion of said hide.

12. The method of claim 11 further comprising a step of processing image data representing said areal image for identifying defects in said hide.

13. The method of claim 11 further comprising a step of processing image data representing said areal image for determining a periphery of at least a portion of said hide.

14. The method of claim 11 further comprising a step of processing image data representing said areal image for determining a surface quality of said hide.

15. The method of claim 11 further comprising a step of combining said at least one areal image so as to form a composite image of a portion of said hide.

16. The method of claim 15 further comprising a step of processing image data representative of said composite image for identifying at least a portion of the periphery of said hide.

17. The method of claim 15 further comprising a step of nesting a pattern piece with respect to said composite image.

18. The method of claim 17 further comprising a step of cutting said pattern piece from said laminate in accordance with said step of nesting.

19. The method of claim 18 wherein said step of nesting includes nesting a plurality of pattern pieces defining a marker and said step of cutting said pattern piece from said laminate occurs generally simultaneously with said step of nesting.

20. A method of making a laminate comprising the steps of:
providing a hide;
providing a backing material having a layer of adhesive disposed on a side thereof;
moving at least one of said hide and said backing material into engagement with one another so that said layer of adhesive is adjacent said hide;
compressing said laminate and adhesively bonding said hide and said backing material together forming a laminate.

21. The method of claim 20 further comprising a step of cutting pattern pieces from said laminate.

22. An apparatus for forming a laminate comprising:
a first support surface for carrying at least one layer of work material;
a second support surface located adjacent said first support surface;
means for transferring said work material between said first and second support surfaces;
a roll of backing material rotatably and operably positioned relative to said first and second support surfaces so that during movement of said work material between said first and second support surfaces said backing material can be fed from said roll into engagement with a surface defined by said work material to form said laminate.

23. The apparatus as defined in claim 22 further comprising means for applying an adhesive to at least one of said work material and said backing material for bonding said backing material to said work material.

24. The apparatus as defined in claim 23 further comprising means for compressing said laminate for bonding said backing material to said work material.

25. The apparatus as defined in claim 23 further comprising a pair of rollers coupled to said second support surface for rotation relative thereto, said rollers having a nip there between and positioned generally perpendicular to the movement of said work material between said first and second support surfaces such that said laminate can be passed between said rollers for compressing said laminate.

26. The apparatus as defined in claim 22 wherein said roll of backing material includes a layer of adhesive disposed on a surface defined by said backing material for bonding said backing material to said work material.

27. The apparatus as defined in claim 22 wherein said work material is a hide.

28. The apparatus as defined in claim 22 wherein said backing material includes foam.

29. The apparatus as defined in claim 26 wherein said roll of backing material further comprises a release material removably bonded to said layer of adhesive for preventing said adhesive from adhering to said backing material on said roll.

30. The apparatus as defined in claim 29 further comprising means for collecting said release material following removal thereof from said backing material.

31. The apparatus as defined in claim 22 further comprising means for feeding said backing material between said first and second support surfaces for engagement with said work material.

32. The apparatus as defined in claim 22 further comprising means for separating said backing material from said roll thereof following engagement of said backing material with said work material.

33. The apparatus as defined in claim 22 further comprising at least one guide roller adjacent to said backing material for facilitating engagement of said backing material with said work material.

34. The apparatus as defined in claim 22 further comprising a controller in communication with said first and second support surfaces for controlling the operation thereof.

35. The apparatus as defined in claim 34 further comprising means for scanning said work material movably coupled to one of said first and second support surfaces.

36. The apparatus as defined in claim 35 further comprising means for cutting pattern pieces from said laminate movably coupled to said second support surface.
